(19) United States
(12) Patent Application Publication
(10) Pub. No.: US 2002/0162191 A1
(43) Pub. Date: Nov. 7, 2002

(54) Compound dual unidirectional friction hinge

(76) Inventor: Chih-Dar Chen, Chin-Men Hsien (TW)

Correspondence Address: BACON & THOMAS, PLLC, 4th Floor, 625 Slaters Lane, Alexandria, VA, 22314-1176, US

(21) Appl. No.: 09/848,313

(22) Filed: May 4, 2001

(51) Int. Cl. E05D 11/08

(52) U.S. Cl. 16/337

(57) ABSTRACT

A compound dual unidirectional friction hinge comprises a pivot pin and two rotary members fastened toward the same direction and being pivotally engaged with the pivot pin. The rotary members have respectively a fastening section and a pivot barrel connecting to the fastening section and pivotally engaging with the pivot pin. The pivot barrel has an edge at one end thereof to form an action gap with the juncture of the fastening section and pivot barrel. When either one of the rotary members is turned, the action gap of the rotary member becomes an open state while the action gap of the non-turning rotary member becomes a closed state and grips the pivot pin thereby to form the unidirectional friction hinge fastened toward the same direction.

### BACKGROUND OF THE INVENTION

This invention relates to a compound dual unidirectional friction hinge and particularly a hinge that is fastened at the same direction and capable of turning in one direction.

The presently known notebook computers or handheld computers generally use a hinge to pivotally connect the display screen with the computer processor. When in use, users may unfold the display screen to see the screen. When not in use, fold the display screen upon the processor to shrink the size and make carrying and storing easier.

The pivotal connection for the display screen and processor set forth above mostly is done through a hinge. A conventional hinge generally consists of a pivot pin and two knuckle sleeves pivotally engaged with the pivot pin. The pivot pin may be disposed on the display screen or the processor. The knuckle sleeves may also be fastened to the display screen or the processor. How to make the arrangement of the pivot pin and knuckle sleeves depends on producers' design. Nevertheless, during turning, the hinge usually is under two states. In the first state, the pivot pin remains stationary and the knuckle sleeves are turning. In the second state the pivot pin is turning but the knuckle sleeves remain stationary. Either way will cause bi-directional friction wearing and metal fatigue. After repetitive using for a long period of time, the gap between the pivot pin peripheral diameter and the knuckle sleeves inner diameter will increase and result in wobbling and producing friction noise when folding or unfolding the display screen.

### SUMMARY OF THE INVENTION

The primary object of this invention is to resolve aforesaid disadvantages by providing two unidirectional hinges facing at the same direction to reduce metal friction wearing and to grip tightly by spiral force at the stationary state.

Another object of this invention is to double the durability of the hinge when turning and producing friction reciprocally at different sides, and to provide two sides of the body for fastening use to reduce fabrication and structure costs.

A further object of this invention is to provide different forces when the hinge is opened and fastened so that there is no need for fastening when the hinge is turned in one direction. The reaction force may restore the elastic force at another side. Hence there is no metal fatigue even under repetitive using. The hinge may have a longer durability.

Still another object of this invention is to provide a dual same-direction construction to maintain one way friction during reciprocal movements thereby to avoid the conventional two-way friction wearing and metal fatigue.

In order to attain the foregoing objects, the hinge of this invention includes a pivot pin and two rotary members pivotally engaged with the pivot pin at the same direction. Each rotary member has a fastening section connecting a pivot barrel which is pivotally engaged with the pivot pin. The pivot barrel has an edge which forms an action gap with the juncture of the fastening section and the pivot barrel. When one of the rotary members is turned, the action gap of the turning rotary member becomes an open state while the action gap of the non-turning rotary member becomes a closed state and grips the pivot pin tightly, therefore to form an unidirectional hinge that is fastened at the same direction.

### BRIEF DESCRIPTION OF THE DRAWINGS

The invention, as well as its many advantages, may be further understood by the following detailed description and drawings, in which:

FIG. 1 is a perspective view of this invention.

FIG. 2 is an exploded view of this invention.

FIGS. 3A and 3B are schematic views of this invention, in action.

FIG. 4 is an exploded view of another embodiment of this invention.

FIG. 5 is an exploded view of a further embodiment of this invention.

### DETAILED DESCRIPTION OF THE PREFERRED EMBODIMENTS

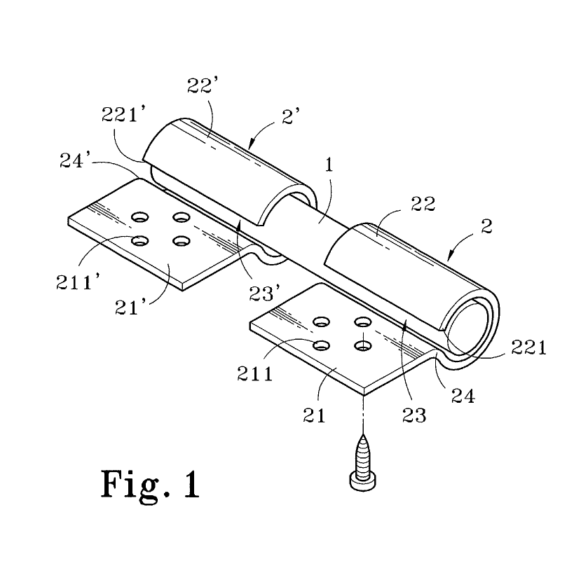

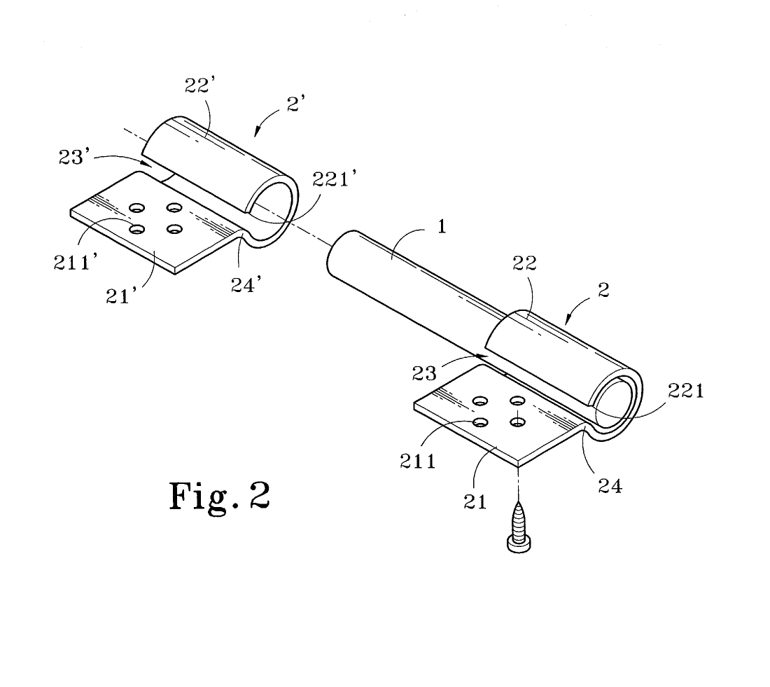

Referring to FIGS. 1 and 2, the hinge according to this invention includes a pivot pin 1 and two rotary members 2 and 2′ pivotally engaged with the pivot pin 1. The rotary member 2 and 2′ are fastened at the same direction, and are turnable in only one direction for reducing metal friction wearing.

The rotary members 2 and 2′ have respectively a fastening section 21 and 21′ which has respectively bores 211 and 211′ for fastening to a structure body of an object desired (such as the cap or cover for opening the display screen of a notebook or handheld computer, or a door frame for opening or closing). The fastening sections 21 and 21′ connect respectively an elastic (or tough) pivot barrel 22 and 22′ which have respectively an edge 221 and 221′ at one end thereof. The edges 221 and 221′ form respectively an action gap 23 and 23′ with the juncture of the fastening sections 21, 21′ and the pivot barrels 22, 22′. The opening and closing status of the action gaps 23 and 23′ determine one of the rotary member 2 and 2′ being turning and another one being non-turning, thereby to form a novel hinge.

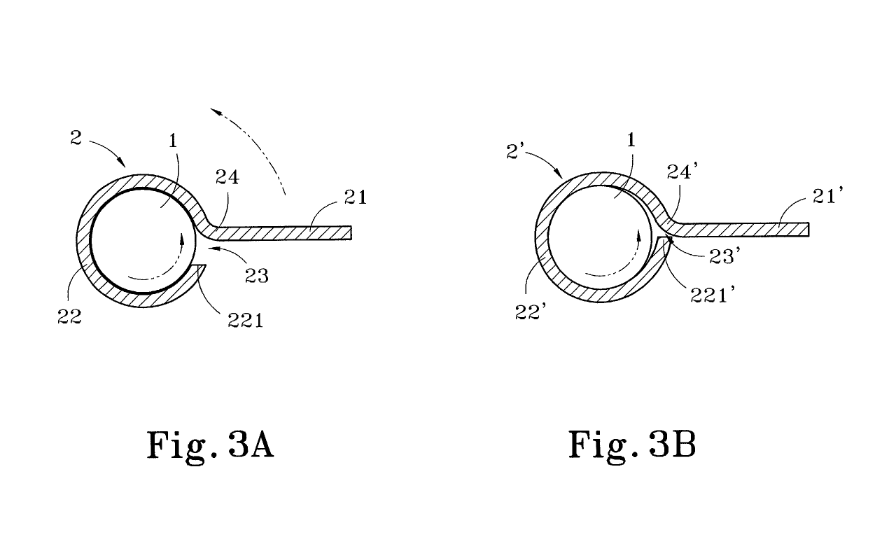

Referring to FIGS. 3A and 3B, when the hinge of this invention is in use, the two rotary members 2 and 2′ are fastened to the structure body A and B of an object. The pivot barrel 22 and 22′ grip the pivot pin 1 tightly. When the structure body A (such as the display screen of a notebook computer) is opened (extended) or unfolded, the pivot barrel 22 of the rotary member 2 fastened to the structure body A will move the pivot pin 1, the peripheral surface of another end of the pivot pin 1 will drag and wind the pivot barrel 22′ of the rotary member 2′ due to static friction such that the action gap 23′ of the rotary member 2′ will become a closed state to make the pivot barrel 22′ gripping the pivot pin 1 tightly. Hence the pivot pin 1 does not turn along the rotary member 2. In the mean time, the action gap 23 of the rotary member 2 is at an open state. Hence by means of the extending movement of the structure body A, the structure body A will extend for a selected angel and stop. When the external force is released from the structure body A, the pivot barrel 22 will automatically grip the pivot pin 1 to form a tight engagement to maintain the structure body A fastened and stationary at the selected angle.

When the structure body A is folded, the rotary members 2 and 2′ are moving contrarily to the motion set forth above to enable the structure body A and B to fold and contract as desired.

As the foregoing turning is a physical phenomenon, the two rotary members 2 and 2′ are facing to the same direction and turning in uni-direction, metal friction wearing may be reduced. The extended angle may also be adjusted to any angle desired.

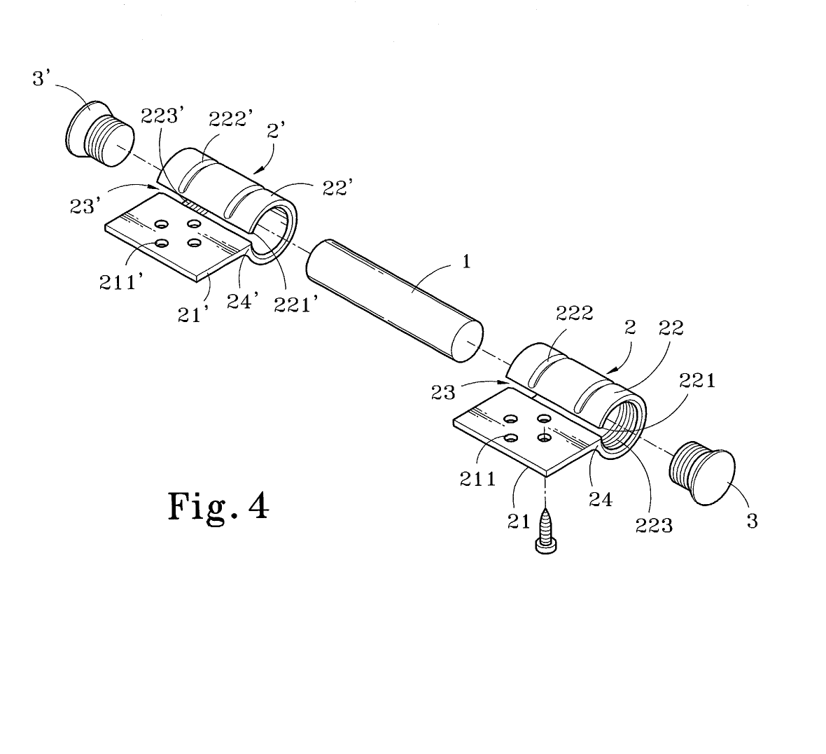

Referring to FIG. 4, it shows another embodiment of this invention which is largely constructed like the one set forth above. The main difference is that there are lubricant slots 222 and 222′ formed respectively in the pivot barrels 22 and 22′ of the rotary members 2 and 2′ for injecting lubricating oil between the pivot barrels 22, 22′ and the rotary pin 1, so that when the rotary members 2 and 2 are turning, the pivot barrels 22 and 22′ may turn smoothly and reduce metal friction between the inner diameter of the pivot barrels 22, 22′ and the peripheral diameter of the pivot pin 1.

Furthermore, an adjust section (with screw threads) 223, 223′ may be formed respectively at the inner perimeter of the pivot barrels 22 and 22′. The adjust section 223, 223′ may couple with an adjust member (a screw or a screw bolt) 3, 3′ which is tapered axially. Turn the adjust member 3, 3′ inwards into the pivot barrels 22, 22′, the inner diameter of the pivot barrels 22, 22′ will be expanded because of the tapered structure of the adjust sections 223, 223′. On the other hand, turn the adjust member 3, 3′ outwards from the pivot barrel 22, 22′, the inner diameter of the pivot barrels 22, 22′ will contract. The expansion and contraction may be used to adjust the torque of the pivot barrels 22, 22′.

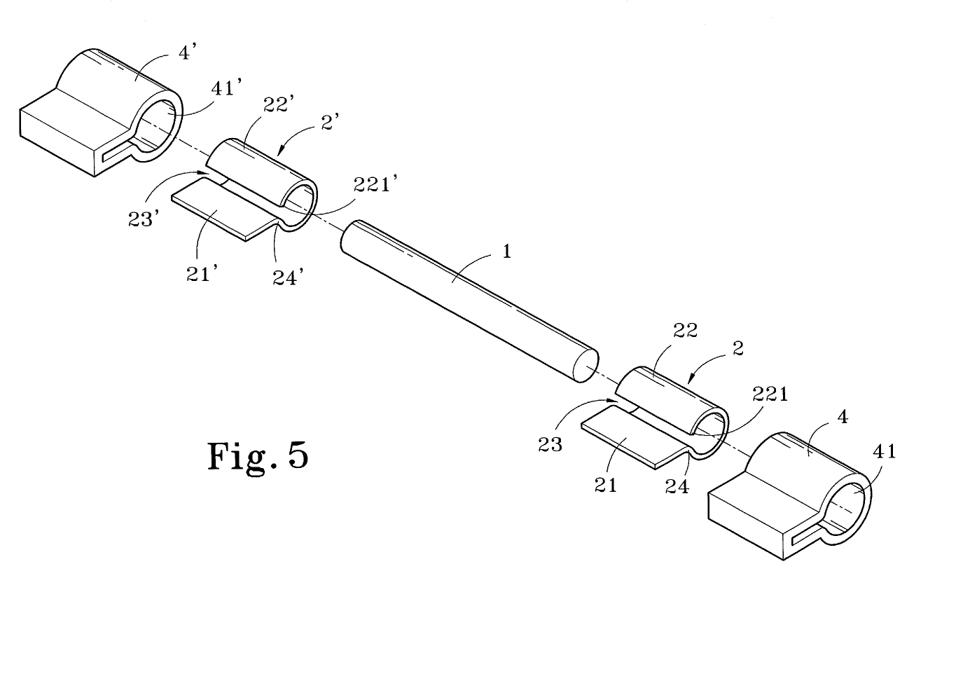

Referring to FIG. 5, it illustrates yet another embodiment of this invention. It has sleeves 4 and 4′ which have respectively a holding chamber 41, 41′ to respectively hold the rotary members 2, 2′ inside so that the hinge may be installed on the structure body A and B of an object in various fastening modes desired. The sleeves 4 and 4′ can also prevent the rotary members 2, 2′ from damaging or losing of turning function resulting from external or environmental factors or influences.

By means of the construction set forth above, this invention offers a number of advantages, notably:

1. The unidirectional turning can reduce metal friction wearing. It will reduce friction force when it is turned for opening and grip tightly with spiral force when stopping. It produces friction at different sides when turning reciprocally, therefore can double the useful life.

2. The two sides of the body can be used for fastening and thus reduce fabrication and structure costs. Moreover, the opening and fastening of the pivot barrel produce different forces which provides an unidirectional turning without the need of fastening. The reaction force can restore the elastic force of another side. Hence the hinge may be used repeatedly with a less likelihood of incurring metal fatigue and may result in a longer durability.

3. The two rotary members are facing at the same direction and will generate only unidirectional friction when under reciprocal movement. The friction wearing and metal fatigue that might otherwise happen to the conventional bi-directional turning thus may be avoided. The lubricant slots in the pivot barrels further may provide desirable lubricating effect to increase service life and prevent dead locking. The addition of adjust members to the pivot barrels can also adjust the turning torque of the rotary members.

What is claimed is:

1. A compound dual unidirectional friction hinge, comprising:
a pivot pin; and
two rotary members pivotally engaged with the pivot pin at a same direction having respectively a fastening section which connect respectively a pivot barrel, the pivot barrel being pivotally engaged with the pivot pin and having an edge at one end thereof to form an action gap with a juncture formed between the fastening section and the pivot barrel;
wherein when either one of the rotary members is turned, the action gap of the turning rotary member becomes an open state, and the action gap of the non-turning rotary member becomes a closed state and grips the pivot pin tightly to form the unidirectional friction hinge fastened toward the same direction.

2. The compound dual unidirectional friction hinge of claim 1, wherein the fastening section have respectively bores for fastening to a structure body of an object.

3. The compound dual unidirectional friction hinge of claim 1, wherein the pivot barrel is elastic or tough.

4. The compound dual unidirectional friction hinge of claim 1, wherein the pivot barrel has lubricant slots.

5. The compound dual unidirectional friction hinge of claim 1, wherein the rotary members couple respectively with at least one sleeve.

6. A compound dual unidirectional friction hinge, comprising:
a pivot pin;
two rotary members pivotally engaged with the pivot pin at a same direction having respectively a fastening section which connect respectively a pivot barrel, the pivot barrel being pivotally engaged with the pivot pin and having an edge at one end thereof to form an action gap with a juncture formed between the fastening section and the pivot barrel, and having an adjust section located therein; and
an adjust member engageable with the adjust section;
wherein when either one of the rotary member is turned, the action gap of the turning rotary member becomes an open state, and the action gap of the non-turning rotary member becomes a closed state and grips the pivot pin tightly to form the unidirectional friction hinge fastened toward the same direction, the adjust member being capable of adjusting the turning torque of the rotary members.

7. The compound dual unidirectional friction hinge of claim 6, wherein the adjust section is a screw thread surface.

8. The compound dual unidirectional friction hinge of claim 6, wherein the adjust member is a screw or a screw bolt.
